(19) United States
(12) Patent Application Publication
(10) Pub. No.: US 2026/0029852 A1
(43) Pub. Date: Jan. 29, 2026

(54) SYSTEM AND METHOD OF HAPTICALLY REPRESENTING A VISUAL SHAPE

(71) Applicant: Apollo Neuroscience, Inc., Pittsburgh, PA (US)

(72) Inventors: David Mayer Lowell Rabin, Bolton Landing, NY (US); Alan C. Cannistraro, Mill Valley, CA (US); Aureliano Pisa, Richmond Hill (CA)

(21) Appl. No.: 19/351,120

(22) Filed: Oct. 6, 2025

Related U.S. Application Data
(63) Continuation of application No. PCT/US2024/023334, filed on Apr. 5, 2024.
(60) Provisional application No. 63/457,897, filed on Apr. 7, 2023.

(51) Int. Cl. G06F 3/01; G06F 3/16

(52) U.S. Cl. CPC G06F 3/016; G06F 3/011; G06F 3/165

(57) ABSTRACT

Systems, apparatus, and methods of haptically representing a shape are disclosed herein. Certain methods include extracting a contour of at least one of a two-dimensional or three-dimensional shape, assigning a plurality of coordinates or parameters along the contour at intervals, and generating a vibratory output pattern corresponding to the contour, wherein the vibratory output pattern comprises one or more variable parameters, and wherein the one or more variable parameters are programmed to correspond to one of the plurality of coordinates or parameters.

### CLAIM TO PRIORITY

This application claims priority to and is a continuation of International Patent Application Serial No. PCT/US2024/023334, filed on Apr. 5, 2024, now published on Oct. 10, 2024, as WO 2024/211756 (Attorney Docket No. APLO-0017-WO).

International Patent Application Serial No. PCT/US2024/023334 claims priority to U.S. Application Ser. No. 63/457,897, filed Apr. 7, 2023 (Attorney Docket No. APLO-0017-P01).

Each of the foregoing patents and/or applications is incorporated herein by reference in its entirety for all purposes.

### BACKGROUND

### Field

Disclosed herein are processes for generating and delivering a haptic representation of a shape.

### Description of the Related Art

Immersive and accessible experiences and communications are sought after more and more by consumers. Haptic technology enables visual and audio experiences to be paired and augmented with vibrotactile stimulation. Representing logos, brands, words, images or other shapes may be coordinated with vibrotactile stimulation to offer a new and accessible way to communicate what was once just sensed visually.

There remains a need for a way to provide a vibrotactile experience that haptically represents or communicates a shape.

### SUMMARY

In some aspects, the disclosure herein relates to a method of haptically representing a shape, including: extracting a contour of a shape; assigning a plurality of coordinates or parameters along the contour at intervals; and generating a vibratory output pattern corresponding to the contour, wherein the vibratory output pattern includes one or more variable parameters, and wherein the one or more variable parameters are programmed to correspond to one of the plurality of coordinates or parameters.

In some aspects, the disclosure herein relates to a system for haptically representing a shape, including: a processor programmed to: extract a contour of a shape; assign a plurality of coordinates or parameters along the contour at intervals; and generate a vibratory output pattern corresponding to the contour, wherein the vibratory output pattern includes one or more variable parameters, and wherein the one or more variable parameters are programmed to correspond to one of the plurality of coordinates or parameters.

In some aspects, the disclosure herein relates to a method of haptic representation, including: receiving input corresponding to a shape; accessing a memory, the memory including a vibratory output pattern corresponding to the shape; and generating the vibratory output pattern, wherein the vibratory output pattern includes one or more variable parameters, and wherein the one or more variable parameters are programmed to correspond to one of a plurality of coordinates or parameters corresponding to a contour of the shape.

In some aspects, the disclosure herein relates to a system for haptic representation, including: a processor programmed to: receive input of a shape; access a memory, the memory including a vibratory output pattern corresponding to the shape; and generate the vibratory output pattern, wherein the vibratory output pattern includes one or more variable parameters, and wherein the one or more variable parameters are programmed to correspond to one of a plurality of coordinates or parameters corresponding to the shape.

In some aspects, the disclosure herein relates to a method of haptic representation, including: receiving at least one of input of a location, an item, or a sound or input from a wearable device, a mobile device, a sensor, a transmitter, a beacon, an application, or a website; accessing a memory, the memory including a vibratory output pattern corresponding to a shape associated with the input; and generating the vibratory output pattern, wherein the vibratory output pattern includes one or more variable parameters, and wherein the one or more variable parameters are programmed to correspond to one of a plurality of coordinates or parameters corresponding to the shape.

In some aspects, the disclosure herein relates to a system for haptic representation, including: a processor programmed to: receive input of at least one of a location, a wearable device, a mobile device, a sensor, a transmitter, a beacon, an item, a sound, an application, or a website; access a memory, the memory including a vibratory output pattern corresponding to a shape associated with the input; and generate the vibratory output pattern, wherein the vibratory output pattern includes one or more variable parameters, and wherein the one or more variable parameters are programmed to correspond to one of a plurality of coordinates or parameters corresponding to a contour of the shape.

In some aspects, the disclosure herein relates to a method of haptic representation, including: receiving input corresponding to a shape; and generating a vibratory output pattern corresponding to the shape, wherein the vibratory output pattern includes one or more variable parameters, and wherein the one or more variable parameters are programmed to correspond to one of a plurality of coordinates or parameters corresponding to at least one of a contour or an outline of the shape.

These and other systems, methods, objects, features, and advantages of the present disclosure will be apparent to those skilled in the art from the following detailed description of the preferred embodiment and the drawings.

All documents mentioned herein are hereby incorporated in their entirety by reference. References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context.

### BRIEF DESCRIPTION OF THE FIGURES

The disclosure and the following detailed description of certain embodiments thereof may be understood by reference to the following figures:

FIG. 1 depicts a flowchart of an example method for haptically representing a shape.

FIG. 2 visually depicts a process for haptically representing a shape.

FIG. 3 depicts a system for haptically representing a shape.

FIG. 4 depicts user interfaces for implementing the systems and methods.

FIG. 5 depicts an example vibe mark and traced shape.

FIG. 6A depicts a method for haptic representation.

FIG. 6B depicts a method for haptic representation.

FIG. 7A depicts a method for haptic representation.

FIG. 7B depicts a method for haptic representation.

FIG. 8 depicts a system for haptic representation.

FIG. 9 depicts options for input.

FIG. 10A depicts a method for haptic representation.

FIG. 10B depicts a method for haptic representation.

FIG. 11A depicts a method for haptic representation.

FIG. 11B depicts a method for haptic representation.

FIG. 12A and 12B depict example haptic representations for a shape.

FIG. 12C depicts parameters for a haptic representation.

### DETAILED DESCRIPTION

Technology has advanced to enable contactless environments in various sectors relating to goods and services as well as contactless communication and experiences. Recent advances in haptic technology have enabled a surge in tactile experiences and tactile communications useful in both contactless experiences and in improving accessibility. For example, as brands look to position themselves in this contactless environment, haptic technology can be leveraged to communicate brand identity with accessibility. As described herein, shapes, such as that of words, images/figures, logos, numbers, or the like, may be represented tactilely. Vibrations may be delivered to a user such that aspects of the vibration, such as intensity, duration, pitch, beat, or the like, provide a corresponding tactile and accessible experience for something being seen. In one example, if the image is that of a mountain, the tactile experience to be delivered may correspond with an outline of the mountain, conveying the slope of ascent as well as its height. In this example, the vibration may ramp up from one intensity to its high intensity and then descend back to the original intensity. In an example, the fast actuation of a transducer followed by a slower actuation may give the feeling of, or otherwise communicate, a directional movement (e.g., a sharp rise followed by a gentle fall), or a pushing/pulling. Coordinated patterns involving changing speed may give the feeling of, or otherwise communicate, three-dimensional stimulation, or the feeling of stimulation changing in certain directions over time.

In another example, an image of rain may be represented by staccato delivery of vibration with varying intensity to represent falling drops of different sizes. Systems and methods will be described herein for how to program a haptic representation of a shape.

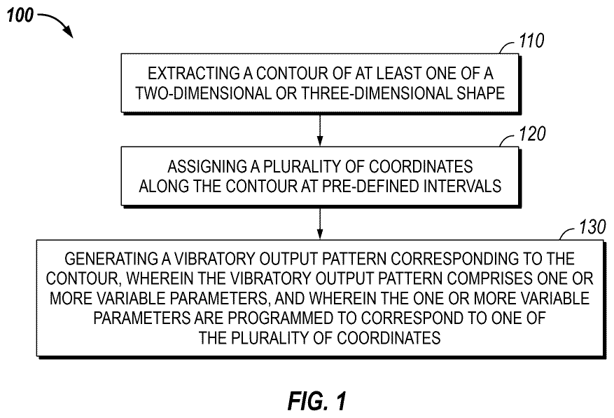

Referring to FIG. 1, depicted is a flowchart of an example method 100 for haptically representing a shape, such as an image, figure, word, object, or logo.

At step 110, a contour or an outline of at least one of a two-dimensional or three-dimensional shape is extracted. Extraction may be an automated process using a processor. In other embodiments, a user interface may be used by the user to define the portions of a shape desired to be represented haptically. For example, and referring now to FIG. 4, a user may use a touch screen interface 400 and run a finger or other tool or implement along a shape to define a shape having a contour or an outline. In some embodiments, the speed at which the user defines one or more portions of the shape may be represented by one or more variable parameters. For example, if the user's tracing of a portion of a three-dimensional shape slows down over time, this may represent a tapering of the portion. Likewise, if the speed ramps up, this may represent an expansion of a dimension of the shape. In some embodiments, increasing speed may be represented by shorter durations between modifications of variable parameters defining the vibratory pattern while decreasing speed may be represented by longer durations between variable parameter modifications.

The interface 400 may have at least one of the following functions, such as to extract 402 a shape, which may be automatic or manual, to save 404 an image or extraction at any stage, to draw 408 a new shape, to define 410 aspects of a shape such as intervals, characteristics, dimensions, or variable vibratory parameters, to add sound 412 to a vibratory pattern, add a grid overlay 418, or the like. In this example, the interface 414 depicts a shape that has been extracted based on the image in the interface 400. The interface 420 depicts a grid overlaid on the extracted image and the interface 422 depicts intervals assigned, either manually or automatically, along the contour, as shown by markers. The interface may also support extraction of other characteristics, such as color, texture, movement, speed of oscillation, directionality, and the like. It should be understood that any characteristic may be represented by one or more variable parameters. It should be understood that while the grid overlay is depicted visually in FIG. 4, no actual gridlines may be depicted in the interface. The action associated with the element labelled 418 is a command for a processor to correlate the shape with a coordinate space and gridlines may simply be a representative depiction of the coordinate space.

The interface may also support assignment and/or modification of variable vibratory parameters at each interval, a capability to test the vibratory pattern, a communication interface to control a haptic motor, a way to add rules and triggers for producing the vibratory pattern as described elsewhere herein, a way to augment the delivery of the vibratory pattern such as by adding sound or coordinating it with one or more visual presentations.

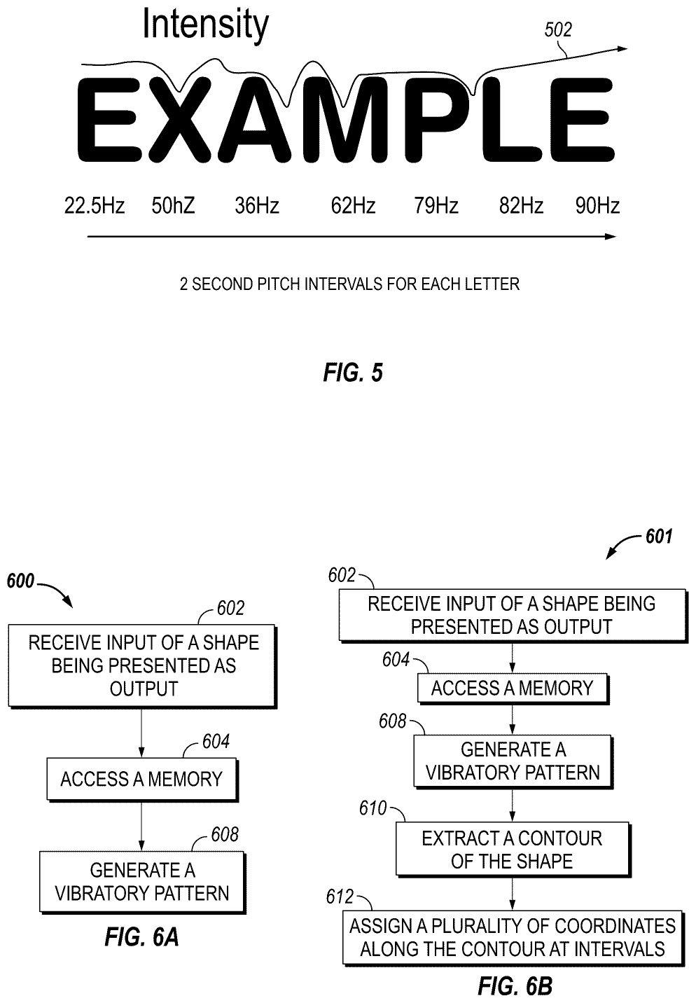

In another example, and referring to FIG. 5, tracing a word mark, such as that shown in FIG. 5, may result in a traced shape 502, where the traced shape 502 comprises the contour of the top of the word. In an embodiment, the traced shape may be a modulator of intensity, that is, the shape of the contour as felt in the time-domain (e.g., its intensity) traces the shape of the contour in the visual space. In the systems and methods, the time-based experience of the modulation of intensity or frequency may map to a contour of the visual representation in a single dimension. Vibration (like audio) is experienced temporally, whereas visuals are up to the viewer to browse however they want. A close approximation of a linear experience in a visual form that maps to a temporal experience is reading. Since in English text is read from left-to-right, the contour of the words from left-to-right would map to the modulation of the vibration. In the example of FIG. 5, the visual has a contour from left to right of a line interrupted by hills and valleys. (Direction of the contour could be reversed, however, based on the direction that text is read in any given language). That contour could be experienced through vibration by modulating intensity according to the traced shape 502 such that the temporal representation or time-based modulation of the vibration is reminiscent of the visual contour.

With continued reference to FIG. 5, each letter in the word ‘EXAMPLE’ represents a pitch, and the top of the word is loosely followed with respect to intensity in a way that creates a vibration experience that conveys aspects of the word. For example, in the example of FIG. 5, the pitch settles at the first pitch of 22.5 Hz at the letter ‘E’ and dwells for a few seconds, then glides to the next pitch at the letter ‘X’ (e.g., 50 Hz) and remains for a few seconds. The glide may continue from one letter to the next at intervals (e.g., 2 seconds per pitch), for example, the pitch may change to 36 Hz for the letter ‘A’, then to 62 Hz for the letter ‘M’, then glide to 79 Hz for the letter ‘P’, 82Hz for ‘L’, then 90 Hz for ‘E’ and then the vibrations may fade out on the last letter. In the example, the intensity rises and falls smoothly, except for at the ‘X’, ‘M’, and between ‘P’ and ‘L’ where those letters are more angular. It should be understood that the pitches, intensity, and pitch intervals can all be varied to customize the haptic representation and user experience.

Returning to FIG. 1, at step 120, a plurality of coordinates, or parameters, are assigned along the contour at intervals. The intervals may correspond with a duration. The intervals may define at least one of an arc segment or an irregular arc segment.

At step 130, a vibratory output pattern is generated corresponding to the contour, wherein the vibratory output pattern comprises one or more variable parameters, and wherein the one or more variable parameters are programmed to correspond to one of the plurality of coordinates/parameters. The vibratory pattern may be generated automatically, in real time, or may be generated in coordination with or by a user. For example, the user interface described at step 110 may be used to define parameters for the vibration along with any associated sensory effects, such as visual or audible effects.

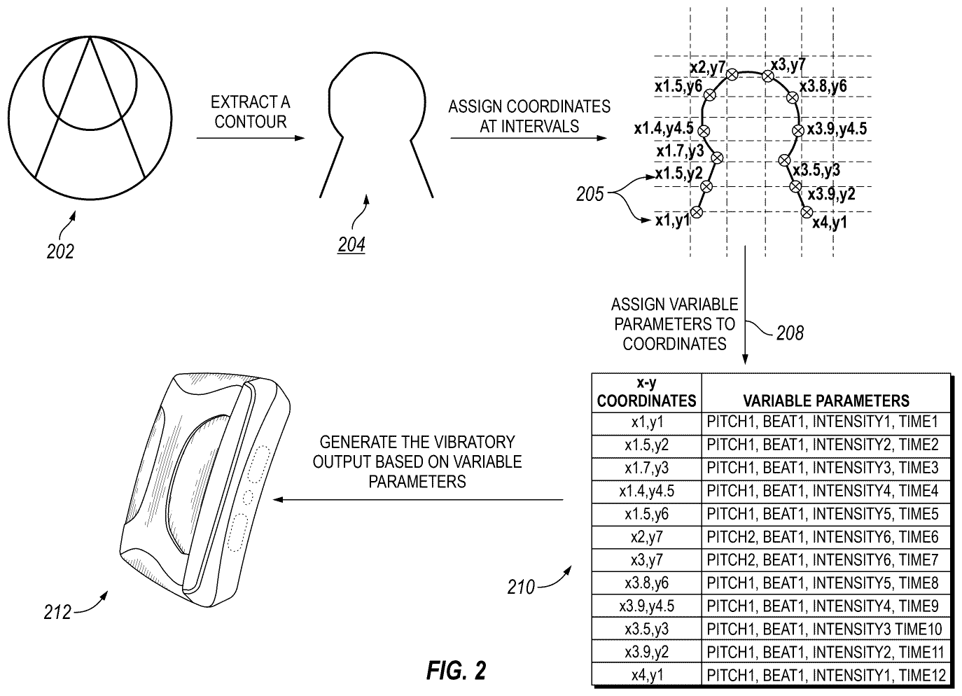

FIG. 2 visually depicts the process described in FIG. 1. An example shape 202, which is the applicant's registered logo (Reg No. 97284869) in this example, is accessed by a processor and a contour 204 of the shape is extracted. In this example, certain of the lines comprising the shape 202 were extracted while others were not extracted. In embodiments, rules may govern what portions of a shape to extract, such as to only extract the outermost portions comprising the shape, or to extract portions with the greatest spatial change over a particular span, or to extract all available lines comprising the shape. In embodiments, along with the shape, other aspects may be extracted, such as dimension, color, texture, or other characteristics. The processor may then assign one or more coordinates to the contour 204, such as at intervals. For example, a contour 204 may be subdivided into a series of defined or arbitrary segments, or subdivided by the pixels used to visually represent the contour 204, or by any other strategy to handle the contour in smaller parts than the whole. In embodiments, to facilitate the assignment of coordinates, a grid may be overlaid onto the contour. In FIG. 2, contour 204 is overlaid with an x, y grid to facilitate assignment of x, y coordinates. At step 208, intervals are also assigned along the contour 204. Coordinates 205, such as x, y, or x, y, z coordinates, may be assigned to the contour 204 at the intervals. In the example of FIG. 2, the contour 204 is divided into 11 equal segments along the length of the contour 204, as defined by the intervals, and x, y coordinates 205 are assigned at the interval that begins each segment. The intervals can be of any segment length and may be chosen to provide sufficient data points to accurately define the shape, such as the span of an arc segment or irregular arc segment. Duration may also be assigned at each interval. For example, time1 may indicate the duration to deliver the transcutaneous vibration defined by pitch1, beat1, and intensity1. At time 2, the transcutaneous vibration being delivered may alter to have parameters of pitch1, beat1, and intensity2 and may be delivered for a time defined by time2. It should be understood that, in embodiments, time1 may not be the same as time2, while in other embodiments, time1 and time2 are equivalent. Indeed, any of the time parameters assigned to a contour may be the same or different from each other and may be of any duration. In this specific example, pitch increases for the x2, y7 and x3, y7 coordinates and returns to the original pitch for subsequent coordinates on the timeline.

Parameters 210 for the transcutaneous vibrations to be delivered may be assigned to the coordinates. For example, the table shown in FIG. 2 lists each of the defined coordinate pairs along with the assigned parameters for each coordinate pair. In this example, a specific pitch, beat, intensity, and time are assigned for each coordinate pair but it should be understood that any parameter for a haptic vibration, including pitch, beat, intensity, frequency, duration, or the like, may be assigned to each coordinate pair and may be varied individually or as a group for each coordinate pair. In some aspects, the correspondence of the one or more variable parameters to the one of the plurality of coordinates/parameters may be defined in a lookup table. In some aspects, the one or more variable parameters may be at least one of a perceived pitch, a perceived beat, or an intensity. In an embodiment, methods for generating transcutaneous vibrations as well as a device for delivering the haptic signal for representing a shape may be as described in United States Patent Application Publication 2022-0362095, filed Jul. 26, 2022, (APLO-0009-U01), PCT International Application WO 2023/229598, filed May 26, 2022, and PCT International Application WO 2024/059191, filed Sep. 14, 2023, the entireties of which are hereby incorporated by reference.

In another example, the shape 202 may be three-dimensional. In this example, the extracted contour 204 may be either two-dimensional or three-dimensional. In embodiments where the contour 204 is three-dimensional, the assigned coordinates may include a z coordinate. To assign the z coordinate, the processor may measure one or more dimensions of the three-dimensional shape. To facilitate such measurement, the shape 202 may once again be overlaid with a grid, such as an x, y, z grid, in this example. For example, the shape 202 may have a depth or may taper along an axis. The third dimension may be assigned the z coordinate. In embodiments, the assigned variable parameters may be selected to represent the x, y, and z coordinate at, or over, each interval. In certain embodiments, each of the x, y, and z coordinates may be assigned one of the variable parameters, pitch, beat, or intensity, wherein each of the parameters may vary in correspondence with a change in the value of the coordinate. In an example, a user may be standing in front of the pyramids at Giza and a device may scan the outline of the pyramid, such as with an image sensor, LIDAR, or the like, and then generate a vibratory output representative of the shape of the pyramid. In another embodiment, the scan may cause the device to recognize that it is a particular pyramid in Giza and the device may access a memory to obtain a vibratory output previously generated for that pyramid. In this way, the systems, methods, and devices of this disclosure provide for an accessible experience for visually impaired individuals.

A memory in communication with the processor may store details of the extracted contour 204, the intervals, the coordinates 205, and the parameters 210 assigned to each coordinate, as well as other details such as an overall duration or number of times to deliver the transcutaneous vibration, corresponding sounds or visuals to present, any rules/triggers associated with the vibratory output, or the like. In an example, when a request is made to deliver a haptic signal representing a shape, the process for contour extraction, coordinate and parameter assignment may only need to be done once, and may be done in real time, and the results may be stored for subsequent delivery. In embodiments, a database of shapes and programmed contours/coordinates/parameters may be available for access by or communication to processors/transducers. The memory may store program code that includes instructions to generate the vibratory pattern.

When a request to deliver a transcutaneous vibration that is intended to haptically represent a shape is received, a transducer 212, which may also be referred to as a haptic motor or a vibratory motor throughout this specification, may generate a vibratory output based on the parameters 210. For example, such a request may be made when an application in communication with the processor controlling the vibratory output is opened/restarted. A memory in communication with a processor having instructions to generate a vibratory pattern may also store rules for when to deliver the vibratory pattern, the actual vibratory pattern to be delivered, and any triggers for delivering, discontinuing, or altering the vibratory pattern. For example, when a user opens a rideshare application, the launch of the application may trigger a vibratory pattern that haptically represents a portion of the logo or some other brand aspect (in the manner described herein), which may be delivered by the device on which the rideshare application was launched or on a separate device, such as a wearable device, in communication with the device running the application. Continuing with the example, additional triggers may be set by the providers of the rideshare application or the user, such as when a rideshare order is confirmed, when the driver is within a particular distance, if the rideshare gets cancelled, if there is a traffic slowdown delaying the driver, or the like. In these examples, there may be no accompanying visual output or no change in an existing visual output.

Intervals may be defined to represent a given shape. The intervals may be selected or defined to represent the shape with a given accuracy. In some embodiments, intervals may be defined to represent a directionality. In the example of FIG. 2 for example, one embodiment may be where all time periods are equivalent. In another embodiment, such as for example if there was a larger x distance following the x2, y7 coordinate, the time defined by time 6 may be longer than other time periods to represent a direction of traverse along the contour over a larger distance.

Continuing with the method depicted in FIG. 1, the vibratory output pattern may be emitted with a haptic motor, such as a haptic motor of a device, such as a mobile device (e.g., smartphone, smart watch, tablet, smart eyewear, etc.) or a wearable device, such as that described in U.S. Patent Application Publication 2022-0362095, filed on Jul. 26, 2022, which also describes systems and methods of generating and providing transcutaneous vibratory stimulation that can be used in conjunction with the embodiments described herein. U.S. Patent Application Publication 2022-0362095 is incorporated by reference herein in its entirety for all purposes. In some embodiments, the vibratory output pattern may be emitted by multiple, coordinated transducers. In embodiments, the processor generating the vibratory program in coordination with the coordinates of the contour may be separate from the device containing the haptic motor, wherein the device simply receives the vibratory pattern to emit, or in some embodiments, the processor and the haptic motor are part of the same device. In embodiments, while the vibratory pattern is being emitted, the shape may be presented as an output concurrently. For example, at startup of an application on a mobile device, a logo may be presented on the screen and a vibratory pattern haptically representing that logo may be emitted concurrently. The launch of the application or the presentation of the image may be the trigger for the vibratory output. The output may take any form, such as on any screen, printed output, a light effect or show, or the coordinated movement of objects, such as drones. The vibratory haptic pattern may be emitted by the mobile device or by a wearable device in communication with the mobile device. In another example, at startup of an application on a device, a vibratory pattern haptically representing the application (e.g., a brand associated with the application) may be emitted concurrently whether or not a visual output is also presented concurrently. In an example, a vibratory pattern may be triggered when a user navigates to a secure website or launches a secure application which signals that the website/app is secure, authentic, or otherwise safe for browsing/interaction. In the example, the vibratory pattern may correspond to an image selected by a user or a brand logo associated with the website/app. The vibratory pattern may be emitted by the device running the website/app or on a device in communication with the device running the website/app. In this way, the vibratory pattern is a personalized security tactile stimulation giving users comfort that the website/app is authentic. Disclosed herein is a method of haptically representing a shape, including: extracting a contour of a shape; assigning a plurality of coordinates, or parameters, along the contour at intervals; and generating a vibratory output pattern corresponding to the contour, wherein the vibratory output pattern includes one or more variable parameters, and wherein the one or more variable parameters are programmed to correspond to one of the plurality of coordinates/parameters.

Also disclosed herein is a system for haptically representing a shape, including: a processor programmed to: extract a contour of a shape; assign a plurality of coordinates, or parameters, along the contour at intervals; and generate a vibratory output pattern corresponding to the contour, wherein the vibratory output pattern includes one or more variable parameters, and wherein the one or more variable parameters are programmed to correspond to one of the plurality of coordinates/parameters.

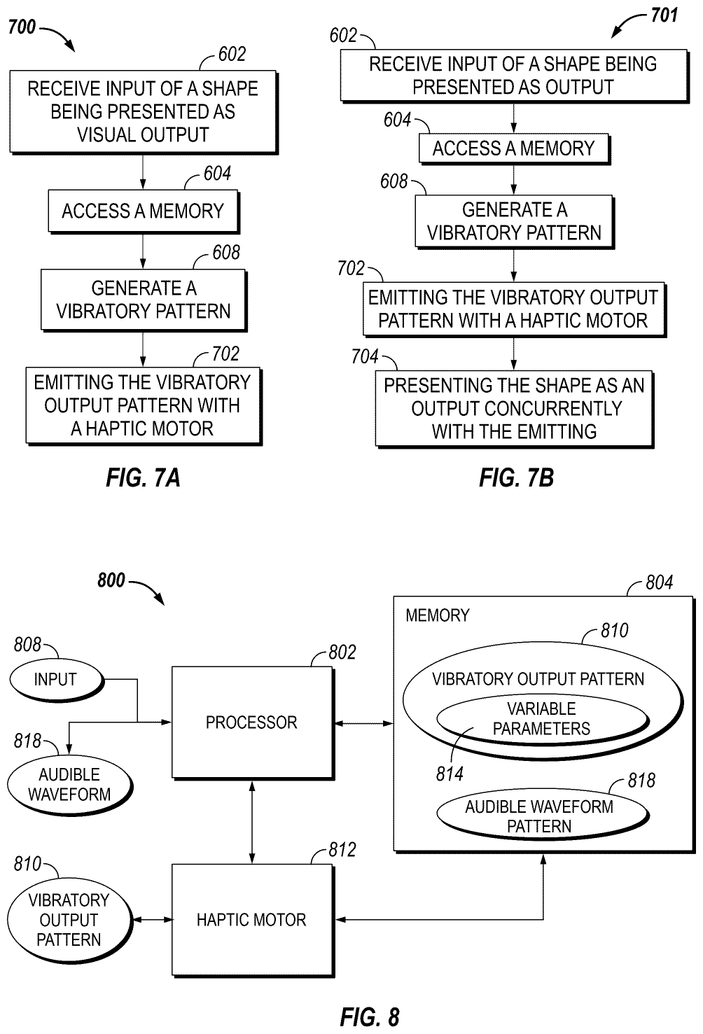

Disclosed herein, and referring to FIG. 6A, is a method 600 for haptic representation, including: an operation 602 of receiving input of a shape being presented as output (e.g., visual output); an operation 604 of accessing a memory, the memory including a vibratory output pattern corresponding to the shape; and an operation 608 of generating the vibratory output pattern, wherein the vibratory output pattern includes one or more variable parameters, and wherein the one or more variable parameters are programmed to correspond to one of a plurality of coordinates/parameters corresponding to a contour of the shape. In examples, and referring to FIG. 6B, the method 601 includes generating the vibratory pattern by an operation 610 of extracting a contour of the shape, and an operation 612 of assigning a plurality of coordinates, or parameters, along the contour at intervals, the vibratory output pattern corresponding to the contour. The vibratory output pattern includes one or more variable parameters, wherein the one or more variable parameters are programmed to correspond to one of the plurality of coordinates/parameters. In embodiments disclosed herein, parameters or dimensions other than contour may be extracted and used as input to the generation to any vibratory pattern herein. For example, the width, height, color, density, or weight of an object may be a parameter used in any of the generation or extraction steps disclosed herein. Extracting a contour, as described herein, may also refer to approximations (including best fit, linear fit, slope, etc.) of the actual contour of an object. Any reference to shape should be understood to include the shape of an object, feature or subject of sensor-captured data. For example, a word itself is understood to be an object in this disclosure and to have a shape. Referring to FIG. 7A, a method 700 (which is inclusive of the steps of method 600) includes an operation 702 of emitting the vibratory output pattern with a haptic motor. Referring to FIG. 7B, a method 701 (which include operations 602, 604, and 608 from method 601) further includes an operation 704 of presenting the shape as an output (e.g., visual output) concurrently with the emitting.

Disclosed herein, and referring to FIG. 8, is a schematic representation of a system or system 800 for haptic representation, including: a processor 802 programmed to: receive input 808 of a shape being presented as output (e.g., visual output); access a memory 804, the memory including a vibratory output pattern 810 corresponding to the shape; and generate the vibratory output pattern, wherein the vibratory output pattern includes one or more variable parameters 814, and wherein the one or more variable parameters 814 are programmed to correspond to one of a plurality of coordinates/parameters corresponding to a contour of the shape.

In some embodiments, the presentation of the shape may have parameters that are coordinated with the vibratory pattern, such as an oscillation, color-changing or shape-changing effect. For example, continuing with the example where the image is a mountain, the mountain may be drawn on screen in real-time while the vibration corresponding to the portion being drawn on screen is emitted. In embodiments, a frequency at which the visual output is oscillating is a same as the one or more variable parameters of the vibratory output pattern. In other embodiments, at least one color of the visual output varies in coordination with the one or more variable parameters of the vibratory output pattern. In yet other embodiments, a size of at least a portion of the visual output varies in coordination with the one or more variable parameters of the vibratory output pattern. In some aspects, a beat of a moving portion of the visual output (e.g., such as rain drops falling) varies in coordination with a beat of the vibratory output pattern. It should be understood that any characteristic, such as color, texture, dimension, size, movement, speed, directionality, brightness, transparency, or the like of the shape (202 for example) may be extracted and may be represented by one or more variable parameters. For example, the parameters of the vibratory pattern may be based on an average, or any other function, of the color or hue of a vertical slice of the shape (202 for example). In another example, the parameters of the vibratory pattern may be based on an average, or any other function, of the color or hue of a horizontal slice of the shape (202 for example).

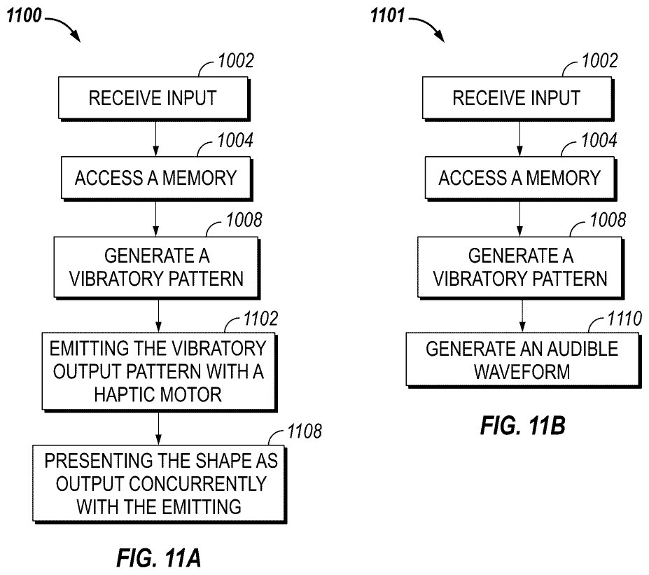

In embodiments, methods disclosed herein, such as the method 100 of FIG. 1 or method 1101 of FIG. 11B, may further include generating an audible waveform pattern corresponding to the contour, wherein the audible waveform pattern includes one or more variable parameters, and wherein the one or more variable parameters are programmed to correspond to one of the plurality of coordinates/parameters. The audible waveform pattern may be emitted concurrently with the vibratory output pattern. In some other embodiments, the audible waveform pattern may be emitted concurrently with the transcutaneous vibration and the presentation of the shape.

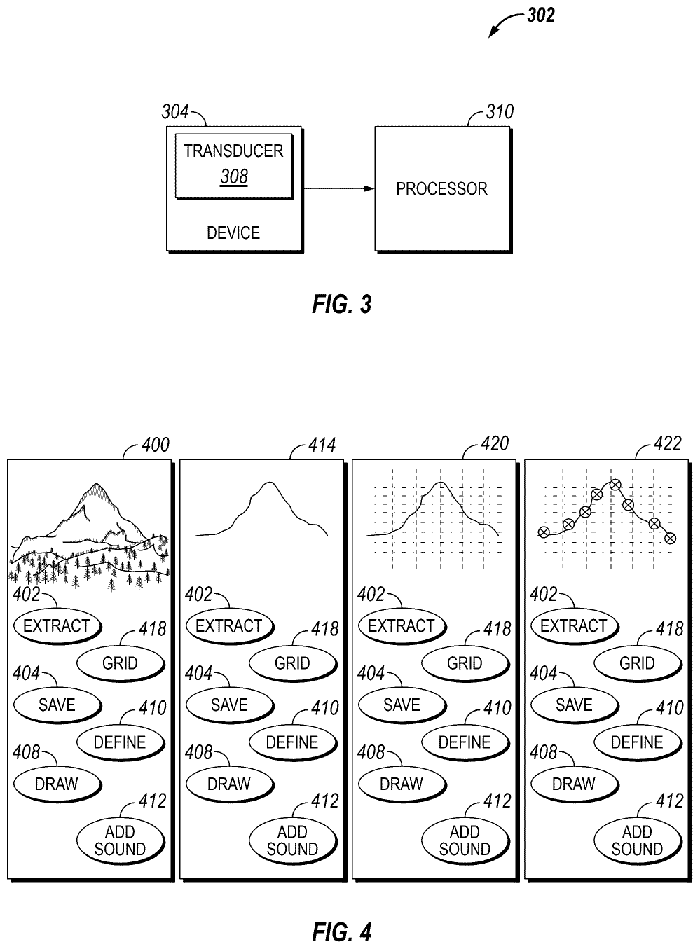

Referring now to FIG. 3, a system 302 for haptically representing a shape may include a device 304, such as a wearable device, mobile device, emitting device, or the like, having a transducer 308 adapted to generate tactile transcutaneous vibratory output, and a processor 310 in electronic communication with the transducer 308 programmed to: extract a contour of a shape (e.g., at least one of a two-dimensional or three-dimensional shape, such as a word, a number, an image, logo, or an object); assign a plurality of coordinates, or parameters, along the contour at intervals, and generate a vibratory output pattern corresponding to the contour, wherein the vibratory output pattern comprises one or more variable parameters, and wherein the one or more variable parameters are programmed to correspond to one of the plurality of coordinates/parameters. The processor may be further programmed to emit the vibratory output pattern with a haptic motor or present the shape as an output concurrently with the emitting.

In examples, the visual output is displayed on the device. In some examples, the visual output is not displayed on the device. For example, the visual output may be displayed on a device comprising the processor or a device in electronic communication with either of the device or the processor. In some examples, the visual output is displayed on both the device and a separate device (e.g., device comprising the processor, third party device).

In embodiments where the visual output is displayed on a second device other than the device, a synchronization may be needed to coordinate the visual output with the vibratory pattern emitting, such as with a trigger. In an example, a user starting an application on a smartphone in electronic communication with the device may be a trigger. In some examples, a trigger rule may govern how often the vibratory pattern is emitted. For example, if the smartphone application continuously crashes, each time it restarts may be a trigger for the vibratory pattern, which may cause a user annoyance. A trigger rule may limit the number of times a vibratory pattern is triggered, such as a total number of times in a time period, or a number of times the vibratory pattern can be delivered in rapid succession.

In embodiments, the visual output may oscillate or a color or size may change in coordination with one or more variable parameters of the vibratory output pattern. A frequency at which the visual output is oscillating may be a same as the one or more variable parameters of the vibratory output pattern. A beat of a moving portion of the visual output may vary in coordination with a beat of the vibratory output pattern. The intervals may include at least one of an arc segment or an irregular arc segment and may correspond with a duration. The correspondence of the one or more variable parameters to the one of the plurality of coordinates/parameters may be defined in a lookup table. The processor may be further programmed to: generate an audible waveform pattern corresponding to the contour, wherein the audible waveform pattern includes one or more variable parameters, and wherein the one or more variable parameters are programmed to correspond to one of the plurality of coordinates/parameters; and emit the audible waveform pattern concurrently with the vibratory output pattern. The one or more variable parameters may be at least one of a perceived pitch, a perceived beat, or an intensity.

In some embodiments, the shape is a static shape in the environment, such as the name of a store or a logo displayed on a sign. For example, a location sensor of the device 304 may detect a proximity to a store which may serve as a trigger to access and then deliver programmed contours/coordinates/parameters associated with the store. In another example, the shape in the environment may be detected by an image sensor, such as a camera of a mobile device or augmented reality eyewear.

In some embodiments, the programmed contours/coordinates/parameters may be stored in a memory of the device, while in other embodiments, the programmed contours/coordinates/parameters are received from a remote location, such as the cloud, a remote server, or an external device, such as an external device in or near the store transmitting the programmed contours/coordinates/parameters continuously, upon request, upon detecting the device, upon detecting motion or performing a face recognition, or the like.

As described herein, various triggers may cause a vibratory pattern to be emitted that haptically represents a shape or some other aspect of the brand. For example, continuing with the example of the rideshare application, once the driver arrives and the user approaches the vehicle, the proximity of the user's mobile or wearable device and the driver's mobile device may be a trigger for the vibratory pattern to be emitted.

In another example, the trigger may be the proximity of the user's wearable or mobile device to a sensor or beacon in or on the rideshare vehicle. In embodiments, the input is a sensed proximity to at least one of a location, a wearable device, a mobile device, a sensor, a transmitter, or a beacon. In embodiments, the input is a receipt of a sensor reading. In embodiments, the input is a recognition of an item. In embodiments, wherein the recognition is a visual recognition. In embodiments, wherein the recognition is an audible recognition. In embodiments, wherein the input is a launch of an application or a navigation to a website. In this way, the triggering of the unique haptic pattern signals a verification, or authenticity, of the rideshare vehicle and/or driver.

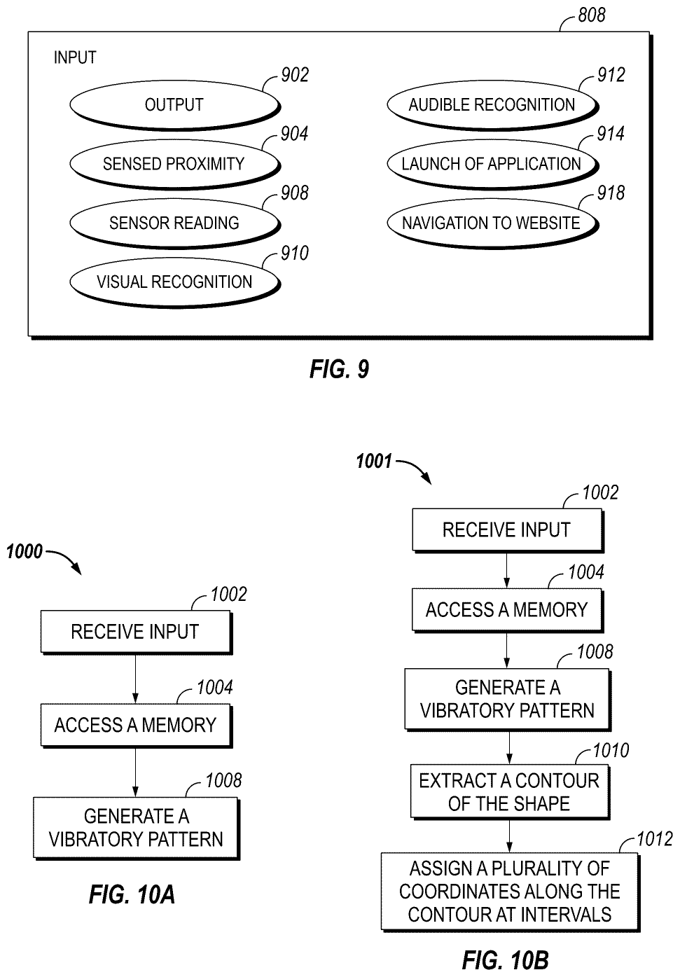

Disclosed herein, and referring to FIG. 10A, a method 1000 for haptic representation may include an operation 1002 of receiving input. Input may be of at least one of a location, such as for example, a location of a storefront or a location of a geographical site. Input could be received from a wearable device (e.g., making a payment with a branded application), a mobile device (e.g., receiving a notification from a branded application), a sensor (e.g., light sensor detects nighttime approaching), a transmitter (e.g., detect user transferring a file to a nearby user), a beacon (e.g., receipt of a broadcast message), an application (e.g., launch of a rideshare application), or a website (e.g., navigation to a branded page). Received input could be regarding proximity to a wearable device, a mobile device, a sensor, a transmitter, a beacon, or an item. Received input could be of a sound (e.g., microphone of device senses audio from ice cream truck as input that triggers presentation of a vibratory pattern for ice cream or a brand of ice cream). The method may include an operation 1004 of accessing a memory, the memory including a vibratory; an operation 1004 of accessing a memory, the memory including a vibratory output pattern corresponding to a shape associated with the input; and an operation 1008 of generating the vibratory output pattern, wherein the vibratory output pattern includes one or more variable parameters, and wherein the one or more variable parameters are programmed to correspond to one of a plurality of coordinates/parameters corresponding to a contour of the shape. Referring to FIG. 10B, a method 1001 may include an operation 1010 of extracting a contour of the shape and an operation 1012 of assigning a plurality of coordinates, or parameters, along the contour at intervals, the vibratory output pattern corresponding to the contour. The vibratory output pattern include one or more variable parameters, wherein the one or more variable parameters are programmed to correspond to one of the plurality of coordinates/parameters. Referring to FIG. 11A, a method 1100 may include an operation 1102 of emitting the vibratory output pattern with a haptic motor, and may include an operation 1108 of presenting the shape as an output concurrently with the emitting. Referring to FIG. 11B, a method 1101 may include an operation 1110 of generating an audible waveform pattern corresponding to the contour, wherein the audible waveform pattern comprises one or more variable parameters, and wherein the one or more variable parameters are programmed to correspond to one of the plurality of coordinates/parameters; and emitting the audible waveform pattern concurrently with the vibratory output pattern. Also disclosed herein is a system for haptic representation, including: a processor programmed to: receive input 808 (shown in FIG. 9), such as a location, or input from or regarding at least one of a wearable device, a mobile device, a sensor, a transmitter, a beacon, an item, a sound, an application, or a website. The processor may also be programmed to access a memory 804 (shown in FIG. 8), the memory including a vibratory output pattern 810 corresponding to a shape associated with the input; and generate the vibratory output pattern 810, wherein the vibratory output pattern includes one or more variable parameters 814, and wherein the one or more variable parameters are programmed to correspond to one of a plurality of coordinates/parameters corresponding to a contour of the shape. Referring to FIG. 9, the input 808 may be an output (e.g., visual) 902, a sensed proximity 904, a sensor reading 908, a visual recognition 910, an audible recognition 912, a launch of an application 914, or a navigation to a website 918.

In embodiments, the processor 802 may be further programmed to emit the vibratory output pattern with a haptic motor 812. In embodiments, the processor 802 may be further programmed to present the shape as an output (e.g., visual) concurrently with the emitting. In embodiments, the processor 802 may be further programmed to generate an audible waveform pattern 818 corresponding to the contour or access one from memory 804, wherein the audible waveform pattern comprises one or more variable parameters, and wherein the one or more variable parameters are programmed to correspond to one of the plurality of coordinates/parameters; and emitting the audible waveform pattern concurrently with the vibratory output pattern.

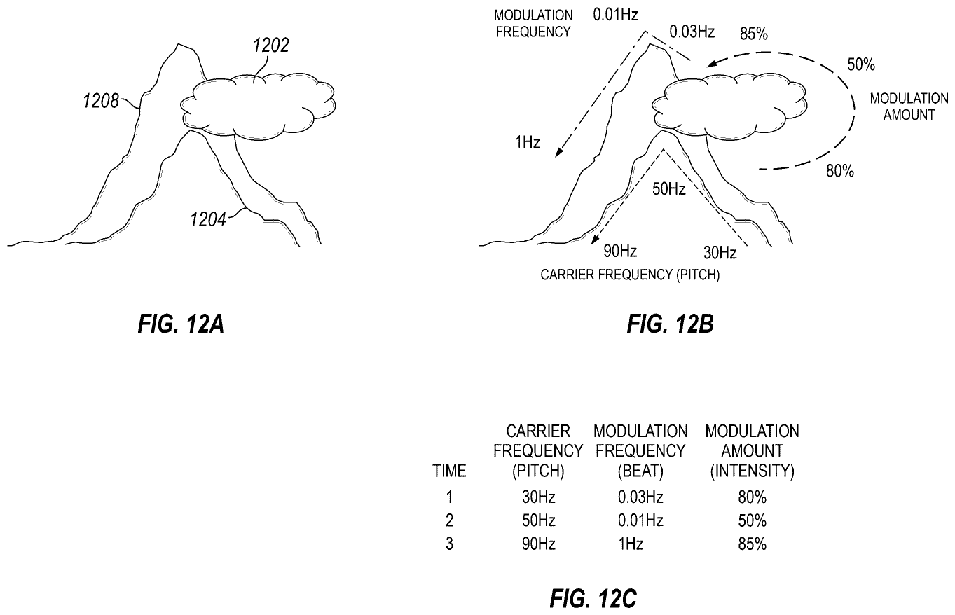

Referring to FIG. 12A, a shape to be represented haptically is depicted including a cloud 1202 near by a larger mountain 1208 and a smaller mountain 1204. FIG. 12B demonstrates an example of parameters that can be used to represent the indicated shape. In this example, elements of the cloud 1202 and the more angular mountains 1204, 1208 are partially followed to form three paths. The paths are 2 dimensional, and only the X or Y (horizontal or vertical) component of the path are used to map to parameters of the vibration pattern. In this case, the X coordinate of the long-dashed path reflects the change of the carrier's amplitude that is affected by the modulation (also referred to as intensity, as shown in FIG. 12C), the Y of the short dash and long dash reflects the changing modulation frequency, and the X of the short dash path reflects the control/change of the carrier's frequency (the pitch). As seen in FIG. 12B and in the table of FIG. 12C, the modulation amount (long dashed path) varies from 80% down to 50% and back up to 85%, the modulation frequency (short and long dash path) varies from 0.03 Hz to 0.01 Hz and ends at 1 Hz, and the carrier frequency (short dash path) starts at 30 Hz then varies to 50 Hz and ends at 90 Hz. The table in FIG. 12C presents the data in terms of timepoints. It should be understood that the values for pitch, beat, and intensity can be modified instantaneously from one to another, or the vibratory pattern may include moving, or gliding through, frequencies between the frequencies that are actually dwelled in.

In examples, the heuristics for converting an image, shape, or word can be iterated on, and further can be used to train and refine a machine learning model to assist in finding best approaches and automating the conversion process.

As described herein, in embodiments, the vibratory output pattern is a distinct, non-audible representation of a brand or a shape, word, number, or characters associated with a brand. Vibration is conveyed transcutaneously/haptically to a customer of the brand through a device having a haptic or vibratory motor. In embodiments, the duration of each vibration is dependent on the time needed to traverse the pattern and may be measured in milliseconds/seconds and may include one or more pauses. As depicted in FIG. 2, parameters 210, including frequencies (which may be expressed in either Hertz (Hz) or beats per minute (BPM)) and amplitudes, are variable in order to customize representation. Amplitudes may be expressed quantitatively, such as in units of gravitational acceleration (G) or using an amplitude scale (e.g., 0-255, or in %), or may be expressed qualitatively, such as “weak” or “strong.”

The methods and systems described herein provide for a number of improvements and benefits to computer technology and fields of tactile stimulation, security, confidentiality, user accessibility and computer interfaces.

The techniques described herein facilitate communications that relate to an image using tactile stimulation. The techniques described herein provide an improvement to computer interfaces as they can generate a tactile description of an image to a user without requiring the user to know or interpret a predefined coding scheme (i.e., Morse code), which enhances user accessibility among other aspects. The techniques described herein can generate a tactile stimulation that provides a description of an image using patterns that can be intuitively interpreted and understood by a user, which enhances user accessibility among other aspects. In one example, improvements to computer interfaces are possible because of the intuitive modulation of stimulation parameters such that they correspond to one or more features of a visualization. In another example, the improvements to computer interfaces are possible because of the extraction and mapping of features of a visualization (for example, coordinates of a line) to parameters of a stimulus signal.

The techniques described herein provide an improvement in the field of security and confidentiality for computer applications. The techniques described herein enable communication redundancy using tactile communication. The techniques described herein provide an auxiliary communication channel that can supplement or provide redundant information related to images. In some applications, a visual communication channel may be compromised by malicious manipulation (i.e., spoofing of websites). In embodiments, tactile stimulations may be used to provide descriptions of an image that may be used to verify that the image is authentic and has not been spoofed or replaced by another image by a malicious party. A tactile stimulation that is generated from the features of an image may be transmitted to a user when a user views the image allowing the user to verify the authenticity of the image by comparing the received tactile stimulation to the features of the image. The tactile verification techniques described herein allow a user to verify an image without the need to divert their attention to another screen and without requiring user knowledge of predefined stimulation patterns. A tactile stimulation pattern, as generated herein, provides an intuitive tactile description of the features of an image, allowing the user to quickly and intuitively confirm that the tactile stimulation corresponds to the features of the image.

The techniques described herein facilitate improvements to methods and systems of tactile stimulation by reducing the hardware and signaling complexity. Traditional methods of tactile communications are limited to simple notifications (i.e., a vibration or lack of vibration to signal a calendar reminder), complex coding (i.e., Morse code encoding to transmit characters), or complex set of transducers and actuators to provide a multi-dimensional grid for tactile feel (i.e., Braille). In contrast, the techniques described herein do not require complex coding and can be used to communicate multi-dimensional features of an image using a few (in many instances, one or less than 10 transducers or motors). The techniques described herein use a signaling technique that does not require user knowledge of a communication code. The techniques described herein use transducers and a signaling technique that utilizes frequency and/or intensity modulation. The modulations are configured to change in the time domain in relation to changes in direction, color, shape, curvature, location, and the like of features in an image. In embodiments, the changes in modulation result in intuitive signaling as they pertain to the image features and do not require a predefined coding scheme that should be memorized by a user.

The methods and systems described herein may be deployed in part or in whole through a machine having a computer, computing device, processor, circuit, and/or server that executes computer readable instructions, program codes, instructions, and/or includes hardware configured to functionally execute one or more operations of the methods and systems disclosed herein. The terms computer, computing device, processor, circuit, and/or server, as utilized herein, should be understood broadly.

A number of example procedures, methods, operations, or the like are set forth throughout the present disclosure. Any such procedures, for example and without limitation as set forth in FIGS. 1, 6A, 6B, 7A, 7B, 10A, 10B, 11A, and 11B, may be performed, in whole or part, by any system, platform, component, processor, apparatus, computing device, or portion thereof, as set forth throughout the present disclosure.

Any one or more of the terms computer, computing device, processor, circuit, and/or server include a computer of any type, capable to access instructions stored in communication thereto such as upon a non-transient computer readable medium, whereupon the computer performs operations of systems or methods described herein upon executing the instructions. In certain embodiments, such instructions themselves comprise a computer, computing device, processor, circuit, and/or server. Additionally or alternatively, a computer, computing device, processor, circuit, and/or server may be a separate hardware device, one or more computing resources distributed across hardware devices, and/or may include such aspects as logical circuits, embedded circuits, sensors, actuators, input and/or output devices, network and/or communication resources, memory resources of any type, processing resources of any type, and/or hardware devices configured to be responsive to determined conditions to functionally execute one or more operations of systems and methods herein.

Network and/or communication resources include, without limitation, local area network, wide area network, wireless, internet, or any other known communication resources and protocols. Example and non-limiting hardware, computers, computing devices, processors, circuits, and/or servers include, without limitation, a general purpose computer, a server, an embedded computer, a mobile device, a virtual machine, and/or an emulated version of one or more of these. Example and non-limiting hardware, computers, computing devices, processors, circuits, and/or servers may be physical, logical, or virtual. A computer, computing device, processor, circuit, and/or server may be: a distributed resource included as an aspect of several devices; and/or included as an interoperable set of resources to perform described functions of the computer, computing device, processor, circuit, and/or server, such that the distributed resources function together to perform the operations of the computer, computing device, processor, circuit, and/or server. In certain embodiments, each computer, computing device, processor, circuit, and/or server may be on separate hardware, and/or one or more hardware devices may include aspects of more than one computer, computing device, processor, circuit, and/or server, for example as separately executable instructions stored on the hardware device, and/or as logically partitioned aspects of a set of executable instructions, with some aspects of the hardware device comprising a part of a first computer, computing device, processor, circuit, and/or server, and some aspects of the hardware device comprising a part of a second computer, computing device, processor, circuit, and/or server.

A computer, computing device, processor, circuit, and/or server may be part of a server, client, network infrastructure, mobile computing platform, stationary computing platform, or other computing platform. A processor may be any kind of computational or processing device capable of executing program instructions, codes, binary instructions and the like. The processor may be or include a signal processor, digital processor, embedded processor, microprocessor or any variant such as a co-processor (math co-processor, graphic co-processor, communication co-processor and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more threads. The thread may spawn other threads that may have assigned priorities associated with them; the processor may execute these threads based on priority or any other order based on instructions provided in the program code. The processor may include memory that stores methods, codes, instructions and programs as described herein and elsewhere. The processor may access a storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache and the like.

A processor may include one or more cores that may enhance speed and performance of a multiprocessor. In embodiments, the process may be a dual core processor, quad core processors, other chip-level multiprocessor and the like that combine two or more independent cores (called a die).

The methods and systems described herein may be deployed in part or in whole through a machine that executes computer readable instructions on a server, client, firewall, gateway, hub, router, or other such computer and/or networking hardware. The computer readable instructions may be associated with a server that may include a file server, print server, domain server, internet server, intranet server and other variants such as secondary server, host server, distributed server and the like. The server may include one or more of memories, processors, computer readable transitory and/or non-transitory media, storage media, ports (physical and virtual), communication devices, and interfaces capable of accessing other servers, clients, machines, and devices through a wired or a wireless medium, and the like. The methods, programs, or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers, and the like. Additionally, this coupling and/or connection may facilitate remote execution of instructions across the network. The networking of some or all of these devices may facilitate parallel processing of program code, instructions, and/or programs at one or more locations without deviating from the scope of the disclosure. In addition, all the devices attached to the server through an interface may include at least one storage medium capable of storing methods, program code, instructions, and/or programs. A central repository may provide program instructions to be executed on different devices. In this implementation, the remote repository may act as a storage medium for methods, program code, instructions, and/or programs.

The methods, program code, instructions, and/or programs may be associated with a client that may include a file client, print client, domain client, internet client, intranet client and other variants such as secondary client, host client, distributed client and the like. The client may include one or more of memories, processors, computer readable transitory and/or non-transitory media, storage media, ports (physical and virtual), communication devices, and interfaces capable of accessing other clients, servers, machines, and devices through a wired or a wireless medium, and the like. The methods, program code, instructions, and/or programs as described herein and elsewhere may be executed by the client. In addition, other devices utilized for execution of methods as described in this application may be considered as a part of the infrastructure associated with the client.

The client may provide an interface to other devices including, without limitation, servers, other clients, printers, database servers, print servers, file servers, communication servers, distributed servers, and the like. Additionally, this coupling and/or connection may facilitate remote execution of methods, program code, instructions, and/or programs across the network. The networking of some or all of these devices may facilitate parallel processing of methods, program code, instructions, and/or programs at one or more locations without deviating from the scope of the disclosure. In addition, all the devices attached to the client through an interface may include at least one storage medium capable of storing methods, program code, instructions, and/or programs. A central repository may provide program instructions to be executed on different devices. In this implementation, the remote repository may act as a storage medium for methods, program code, instructions, and/or programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules, and/or components as known in the art. The computing and/or non-computing device(s) associated with the network infrastructure may include, apart from other components, a storage medium such as flash memory, buffer, stack, RAM, ROM and the like. The methods, program code, instructions, and/or programs described herein and elsewhere may be executed by one or more of the network infrastructural elements.

The methods, program code, instructions, and/or programs described herein and elsewhere may be implemented on a cellular network having multiple cells. The cellular network may either be frequency division multiple access (FDMA) network or code division multiple access (CDMA) network. The cellular network may include mobile devices, cell sites, base stations, repeaters, antennas, towers, and the like.

The methods, program code, instructions, and/or programs described herein and elsewhere may be implemented on or through mobile devices. The mobile devices may include navigation devices, cell phones, mobile phones, mobile personal digital assistants, laptops, palmtops, netbooks, pagers, electronic books readers, music players, and the like. These mobile devices may include, apart from other components, a storage medium such as a flash memory, buffer, RAM, ROM and one or more computing devices. The computing devices associated with mobile devices may be enabled to execute methods, program code, instructions, and/or programs stored thereon. Alternatively, the mobile devices may be configured to execute instructions in collaboration with other devices. The mobile devices may communicate with base stations interfaced with servers and configured to execute methods, program code, instructions, and/or programs. The mobile devices may communicate on a peer to peer network, mesh network, or other communications network. The methods, program code, instructions, and/or programs may be stored on the storage medium associated with the server and executed by a computing device embedded within the server. The base station may include a computing device and a storage medium. The storage device may store methods, program code, instructions, and/or programs executed by the computing devices associated with the base station.

The methods, program code, instructions, and/or programs may be stored and/or accessed on machine readable transitory and/or non-transitory media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g., USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

Certain operations described herein include interpreting, receiving, and/or determining one or more values, parameters, inputs, data, or other information. Operations including interpreting, receiving, and/or determining any value parameter, input, data, and/or other information include, without limitation: receiving data via a user input; receiving data over a network of any type; reading a data value from a memory location in communication with the receiving device; utilizing a default value as a received data value; estimating, calculating, or deriving a data value based on other information available to the receiving device; and/or updating any of these in response to a later received data value. In certain embodiments, a data value may be received by a first operation, and later updated by a second operation, as part of the receiving a data value. For example, when communications are down, intermittent, or interrupted, a first operation to interpret, receive, and/or determine a data value may be performed, and when communications are restored an updated operation to interpret, receive, and/or determine the data value may be performed.

Certain logical groupings of operations herein, for example methods or procedures of the current disclosure, are provided to illustrate aspects of the present disclosure. Operations described herein are schematically described and/or depicted, and operations may be combined, divided, re-ordered, added, or removed in a manner consistent with the disclosure herein. It is understood that the context of an operational description may require an ordering for one or more operations, and/or an order for one or more operations may be explicitly disclosed, but the order of operations should be understood broadly, where any equivalent grouping of operations to provide an equivalent outcome of operations is specifically contemplated herein. For example, if a value is used in one operational step, the determining of the value may be required before that operational step in certain contexts (e.g. where the time delay of data for an operation to achieve a certain effect is important), but may not be required before that operation step in other contexts (e.g. where usage of the value from a previous execution cycle of the operations would be sufficient for those purposes). Accordingly, in certain embodiments an order of operations and grouping of operations as described is explicitly contemplated herein, and in certain embodiments re-ordering, subdivision, and/or different grouping of operations is explicitly contemplated herein.

The methods and systems described herein may transform physical and/or or intangible items from one state to another. The methods and systems described herein may also transform data representing physical and/or intangible items from one state to another.

The elements described and depicted herein, including in flow charts, block diagrams, and/or operational descriptions, depict and/or describe specific example arrangements of elements for purposes of illustration. However, the depicted and/or described elements, the functions thereof, and/or arrangements of these, may be implemented on machines, such as through computer executable transitory and/or non-transitory media having a processor capable of executing program instructions stored thereon, and/or as logical circuits or hardware arrangements. Example arrangements of programming instructions include at least: monolithic structure of instructions; standalone modules of instructions for elements or portions thereof; and/or as modules of instructions that employ external routines, code, services, and so forth; and/or any combination of these, and all such implementations are contemplated to be within the scope of embodiments of the present disclosure Examples of such machines include, without limitation, personal digital assistants, laptops, personal computers, mobile phones, other handheld computing devices, medical equipment, wired or wireless communication devices, transducers, chips, calculators, satellites, tablet PCS, electronic books, gadgets, electronic devices, devices having artificial intelligence, computing devices, networking equipment, servers, routers and the like. Furthermore, the elements described and/or depicted herein, and/or any other logical components, may be implemented on a machine capable of executing program instructions. Thus, while the foregoing flow charts, block diagrams, and/or operational descriptions set forth functional aspects of the disclosed systems, any arrangement of program instructions implementing these functional aspects are contemplated herein. Similarly, it will be appreciated that the various steps identified and described above may be varied, and that the order of steps may be adapted to particular applications of the techniques disclosed herein. Additionally, any steps or operations may be divided and/or combined in any manner providing similar functionality to the described operations. All such variations and modifications are contemplated in the present disclosure. The methods and/or processes described above, and steps thereof, may be implemented in hardware, program code, instructions, and/or programs or any combination of hardware and methods, program code, instructions, and/or programs suitable for a particular application. Example hardware includes a dedicated computing device or specific computing device, a particular aspect or component of a specific computing device, and/or an arrangement of hardware components and/or logical circuits to perform one or more of the operations of a method and/or system. The processes may be implemented in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and computer readable instructions, or any other machine capable of executing program instructions.

Thus, in one aspect, each method described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or computer-readable instructions described above. All such permutations and combinations are contemplated in embodiments of the present disclosure.

While the disclosure has been disclosed in connection with the preferred embodiments shown and described in detail, various modifications and improvements thereon will become readily apparent to those skilled in the art. Accordingly, the spirit and scope of the present disclosure is not to be limited by the foregoing examples, but is to be understood in the broadest sense allowable by law.

1. A method of haptically representing a shape, comprising:
extracting a contour of a shape;
assigning a plurality of coordinates or parameters along the contour at intervals; and
generating a vibratory output pattern corresponding to the contour, wherein the vibratory output pattern comprises one or more variable parameters, and wherein the one or more variable parameters are programmed to correspond to one of the plurality of coordinates or parameters.

2. The method of claim 1, further comprising, emitting the vibratory output pattern with a haptic motor.

3. The method of claim 2, further comprising, presenting the shape as an output concurrently with the emitting.

4. The method of claim 3, wherein the output oscillates in coordination with the vibratory output pattern.

5. The method of claim 4, wherein a frequency at which the output is oscillating is a same as the one or more variable parameters of the vibratory output pattern.

6. The method of claim 3, wherein at least one color of the output varies in coordination with the one or more variable parameters of the vibratory output pattern.

7. The method of claim 3, wherein a size of at least a portion of the output varies in coordination with the one or more variable parameters of the vibratory output pattern.

8. The method of claim 3, wherein a beat of a moving portion of the output varies in coordination with a beat of the vibratory output pattern.

9. The method of claim 1, wherein the intervals define at least one of an arc segment or an irregular arc segment.

10. The method of claim 1, wherein the intervals correspond with a duration.

11. The method of claim 1, wherein the shape is at least one of a two-dimensional or three-dimensional shape.

12. The method of claim 1, wherein the shape corresponds to at least one of a word, a number, or an image.

13. The method of claim 1, wherein a correspondence of the one or more variable parameters to the one of the plurality of coordinates or parameters are defined in a lookup table.

14. The method of claim 1, further comprising, generating an audible waveform pattern corresponding to the contour, wherein the audible waveform pattern comprises one or more variable parameters, and wherein the one or more variable parameters are programmed to correspond to one of the plurality of coordinates or parameters; and emitting the audible waveform pattern concurrently with the vibratory output pattern.

15. The method of claim 1, wherein the one or more variable parameters are at least one of a perceived pitch, a perceived beat, or an intensity.

16. A system for haptically representing a shape, comprising:
a processor programmed to:
extract a contour of a shape;
assign a plurality of coordinates or parameters along the contour at intervals; and
generate a vibratory output pattern corresponding to the contour, wherein the vibratory output pattern comprises one or more variable parameters, and wherein the one or more variable parameters are programmed to correspond to one of the plurality of coordinates or parameters.

17. The system of claim 16, further comprising a device having a transducer in electronic communication with the processor, the transducer adapted to generate tactile transcutaneous vibratory output.

18.-21. (canceled)

22. The system of claim 17, wherein the processor is further programmed to present the shape as an output concurrently with the generating tactile transcutaneous vibratory output. 23-32. (canceled)

33. The system of claim 16, wherein the processor is further programmed to:
generate an audible waveform pattern corresponding to the contour, wherein the audible waveform pattern comprises one or more variable parameters, and wherein the one or more variable parameters are programmed to correspond to one of the plurality of coordinates or parameters; and
emit the audible waveform pattern concurrently with the vibratory output pattern.

34. (canceled)

35. A method of haptic representation, comprising:
receiving input corresponding to a shape;
accessing a memory, the memory including a vibratory output pattern corresponding to the shape; and
generating the vibratory output pattern, wherein the vibratory output pattern comprises one or more variable parameters, and wherein the one or more variable parameters are programmed to correspond to one of a plurality of coordinates or parameters corresponding to a contour of the shape.

36.-122. (canceled)
